(19) United States
(12) Patent Application Publication
(10) Pub. No.: US 2025/0337472 A1
(43) Pub. Date: Oct. 30, 2025

(54) APPARATUS AND METHOD FOR SELECTING AN ODD NUMBER OF ANTENNA PORTS FOR SOUNDING REFERENCE SIGNAL RESOURCE TRANSMISSION

(71) Applicant: Nokia Technologies Oy, Espoo (FI)

(72) Inventors: Juha Pekka KARJALAINEN, Sotkamo (FI); Sami-Jukka HAKOLA, Oulu (FI); Timo KOSKELA, Oulu (FI); Youngsoo YUK, Seoul (KR)

(73) Assignee: Nokia Technologies Oy, Espoo (FI)

(21) Appl. No.: 19/188,313

(22) Filed: Apr. 24, 2025

(30) Foreign Application Priority Data
Apr. 29, 2024 (GB) 2405957.8

(51) Int. Cl. H04B 7/06; H04L 5/00

(52) U.S. Cl. CPC H04B 7/0691; H04L 5/0091

(57) ABSTRACT

The present disclosure relates to an apparatus comprising at least one processor and at least one memory storing instructions that, when executed by the at least one processor, cause the apparatus at least to perform: Receiving, from an access node, a sounding reference signal resource configuration for an odd number of antenna ports. The odd number is at least three. Sorting a plurality of antenna branches associated with a plurality of implementation loss values in an ascending order according to the plurality of implementation loss values. Selecting the odd number of antenna branches from within the plurality of antenna branches, wherein the odd number of antenna branches are associated with the odd number of smallest implementation loss values from within the plurality of implementation loss values. Associating the selected odd number of antenna branches with the odd number of antenna ports for sounding reference signal resource transmission.

### TECHNICAL FIELD

Various example embodiments described herein relate to the field of wireless communications.

### BACKGROUND

High peak data rate for uplink (UL) may play a significant role in, e.g., short-range applications as such home entertainment, video surveillance/monitoring in industrial/healthcare/safety applications, integrated access and backhaul (IAB), extended reality (XR), and other applications wherein power/form-factor/cost may not be as stringent as in traditional handheld devices. Use of large antenna arrays, in terms of physical antenna elements and logical antenna ports, may be used in 6G to enable enhanced UL coverage and spectral efficiency with both new and existing frequency bands.

Facilitating use of an odd number of antenna ports in association with UL sounding reference signal (SRS) with antenna ports that may be noncoherent in phase and/or amplitude may enable a network to estimate UL CSI by using UL SRS antenna ports more reliably. Thus, such UL SRS resource configurations for an odd number of antenna ports may be beneficial to enable robust and/or reliable UL channel state information (CSI) acquisition.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments of the present disclosure may enable improving channel estimation accuracy. This benefit may be achieved by the features of the independent claims. Further example embodiments are provided in the dependent claims, the detailed description, and the drawings.

According to a first aspect, an apparatus is disclosed. The apparatus may comprise at least one processor and at least one memory storing instructions that, when executed by the at least one processor, may cause the apparatus at least to perform: receiving, from an access node, a sounding reference signal resource configuration for an odd number of antenna ports. The odd number may be at least three. Sorting a plurality of antenna branches associated with a plurality of implementation loss values in an ascending order according to the plurality of implementation loss values. Selecting the odd number of antenna branches from within the plurality of antenna branches. The odd number of antenna branches may be associated with the odd number of smallest implementation loss values from within the plurality of implementation loss values. Associating the selected odd number of antenna branches with the odd number of antenna ports for sounding reference signal resource transmission. The apparatus may be a user equipment.

Such an apparatus may enable usage of best available antenna ports even when the ranking of the antenna ports is known by the apparatus only.

According to an example embodiment of the first aspect, the at least one processor and the at least one memory storing instructions that, when executed by the at least one processor, may cause the apparatus further to perform: Associating the selected odd number antenna branches with the odd number of antenna ports for physical uplink shared channel transmission.

According to an example embodiment of the first aspect, the sounding reference signal configuration may comprise at least a first number of comb-offset values. The at least one processor and the at least one memory storing instructions that, when executed by the at least one processor, may cause the apparatus further to perform: Obtaining a second number indicating antenna ports per comb-offset value. Determining, based on the sounding reference signal resource configuration and the second number, a mapping between the set of antenna ports and the first number of comb-offset values.

According to an example embodiment of the first aspect, the at least one processor and the at least one memory storing instructions that, when executed by the at least one processor, may cause the apparatus further to perform the determining the mapping between the odd number of antenna ports and the first number of comb-offset values by: Determining the odd number of cyclic-shift values, one cyclic-shift value per antenna port within the odd number of antenna ports. Determining a third number of full antenna port groups. The third number may be a floor operation of the odd number divided by the second number. Each full antenna port group may comprise the second number of antenna port indices in an ascending order and the second number of cyclic-shift values in an ascending order. Associating the third number of comb-offset values within the first number of comb-offset values with the third number of full antenna port groups, comb-offset value per full antenna port group. Determining, in response to the third number being smaller than the first number, a partially full antenna port group comprising a fourth number of antenna port indices and the fourth number of cyclic-shift values. The fourth number is the odd number decreased by the second number multiplied by the third number. Associating, in response to the third number being smaller than the first number, a remaining comb-offset value with the partially full antenna port group.

According to an example embodiment of the first aspect, the second number indicating antenna ports per comb-offset value may be comprised in the sounding reference signal resource configuration.

According to an example embodiment of the first aspect, the second number indicating antenna ports per comb-offset value may be a pre-determined value.

According to an example embodiment of the first aspect, the at least one processor and the at least one memory storing instructions that, when executed by the at least one processor, may cause the apparatus further to perform, prior to the receiving the sounding reference signal resource configuration: Transmitting, to the access node, an indication of uplink transmitting antenna port capability with the odd number of antenna ports. Transmitting, to the access node, an indication of phase and/or amplitude coherence associated with the odd number of antenna ports.

According to a second aspect, a method is disclosed. The method may be a computer-implemented method. The method may comprise: Receiving, from an access node, a sounding reference signal resource configuration for an odd number of antenna ports. The odd number may be at least three. Sorting a plurality of antenna branches associated with a plurality of implementation loss values in an ascending order according to the plurality of implementation loss values. Selecting the odd number of antenna branches from within the plurality of antenna branches. The odd number of antenna branches may be associated with the odd number of smallest implementation loss values from within the plurality of implementation loss values. Associating the selected odd number of antenna branches with the odd number of antenna ports for sounding reference signal resource transmission.

According to an example embodiment of to the second aspect, the method may further comprise: Associating the selected odd number antenna branches with the odd number of antenna ports for physical uplink shared channel transmission. According to an example embodiment of to the second aspect, the method may further comprise: Obtaining a second number indicating antenna ports per comb-offset value. Determining, based on the sounding reference signal resource configuration and the second number, a mapping between the set of antenna ports and the first number of comb-offset values.

According to an example embodiment of the second aspect, the determining the mapping between the odd number of antenna ports and the first number of comb-offset values may comprise: Determining the odd number of cyclic-shift values, one cyclic-shift value per antenna port within the odd number of antenna ports. Determining a third number of full antenna port groups. The third number may be a floor operation of the odd number divided by the second number. Each full antenna port group may comprise the second number of antenna port indices in an ascending order and the second number of cyclic-shift values in an ascending order. Associating the third number of comb-offset values within the first number of comb-offset values with the third number of full antenna port groups, comb-offset value per full antenna port group. Determining, in response to the third number being smaller than the first number, a partially full antenna port group comprising a fourth number of antenna port indices and the fourth number of cyclic-shift values. The fourth number may be the odd number decreased by the second number multiplied by the third number. Associating, in response to the third number being smaller than the first number, a remaining comb-offset value with the partially full antenna port group.

According to a third aspect, an apparatus is provided. The apparatus may comprise: means for receiving, from an access node, a sounding reference signal resource configuration for an odd number of antenna ports, wherein the odd number may be at least three; means for sorting a plurality of antenna branches associated with a plurality of implementation loss values in an ascending order according to the plurality of implementation loss values; means for selecting the odd number of antenna branches from within the plurality of antenna branches, wherein the odd number of antenna branches are associated with the odd number of smallest implementation loss values from within the plurality of implementation loss values; and means for associating the selected odd number of antenna branches with the odd number of antenna ports for sounding reference signal resource transmission.

According to an example embodiment of the third aspect, the apparatus may further comprise means for associating the selected odd number antenna branches with the odd number of antenna ports for physical uplink shared channel transmission.

According to an example embodiment of the third aspect, the sounding reference signal configuration may comprise at least a first number of comb-offset values. The apparatus may further comprise: means for obtaining a second number indicating antenna ports per comb-offset value; and means for determining, based on the sounding reference signal resource configuration and the second number, a mapping between the set of antenna ports and the first number of comb-offset values.

According to an example embodiment of the third aspect, the means for determining the mapping between the odd number of antenna ports and the first number of comb-offset values may comprise: means for determining the odd number of cyclic-shift values, one cyclic-shift value per antenna port within the odd number of antenna ports; means for determining a third number of full antenna port groups, wherein the third number is a floor operation of the odd number divided by the second number, and wherein each full antenna port group comprises the second number of antenna port indices in an ascending order and the second number of cyclic-shift values in an ascending order; means for associating the third number of comb-offset values within the first number of comb-offset values with the third number of full antenna port groups, comb-offset value per full antenna port group; means for determining, in response to the third number being smaller than the first number, a partially full antenna port group comprising a fourth number of antenna port indices and the fourth number of cyclic-shift values, wherein the fourth number is the odd number decreased by the second number multiplied by the third number; and means for associating, in response to the third number being smaller than the first number, a remaining comb-offset value with the partially full antenna port group.

According to an example embodiment of the third aspect, the second number indicating antenna ports per comb-offset value may be comprised in the sounding reference signal resource configuration.

According to an example embodiment of the third aspect, the second number indicating antenna ports per comb-offset value may be a pre-determined value.

According to an example embodiment of the third aspect, the apparatus may further comprise: means for transmitting, prior to the receiving the sounding reference signal resource configuration, to the access node, an indication of uplink transmitting antenna port capability with the odd number of antenna ports; and/or means for transmitting, prior to the receiving the sounding reference signal resource configuration, to the access node, an indication of phase and/or amplitude coherence associated with the odd number of antenna ports.

According to a fourth aspect, a computer-readable medium is disclosed. The computer-readable medium may comprise instructions for causing an apparatus to perform at least the following: Receiving, from an access node, a sounding reference signal resource configuration for an odd number of antenna ports. The odd number may be at least three. Sorting a plurality of antenna branches associated with a plurality of implementation loss values in an ascending order according to the plurality of implementation loss values. Selecting the odd number of antenna branches from within the plurality of antenna branches. The odd number of antenna branches may be associated with the odd number of smallest implementation loss values from within the plurality of implementation loss values. Associating the selected odd number of antenna branches with the odd number of antenna ports for sounding reference signal resource transmission.

According to a fifth aspect, a computer program is disclosed. The computer program may comprise instructions for causing an apparatus to perform at least the following: Receiving, from an access node, a sounding reference signal resource configuration for an odd number of antenna ports. The odd number may be at least three. Sorting a plurality of antenna branches associated with a plurality of implementation loss values in an ascending order according to the plurality of implementation loss values. Selecting the odd number of antenna branches from within the plurality of antenna branches. The odd number of antenna branches may be associated with the odd number of smallest implementation loss values from within the plurality of implementation loss values. Associating the selected odd number of antenna branches with the odd number of antenna ports for sounding reference signal resource transmission.

According to a sixth aspect, an apparatus is disclosed. The apparatus may comprise at least one processor and at least one memory storing instructions that, when executed by the at least one processor, may cause the apparatus at least to perform: Receiving, from an access node, a sounding reference signal resource configuration for an odd number of antenna ports. The sounding reference signal configuration may comprise at least a first number of comb-offset values. The odd number may be at least three. Obtaining a second number indicating a number of antenna ports per comb-offset value. Determining, based on the sounding reference signal resource configuration and the second number, a mapping between the odd number of antenna ports and the first number of comb-offset values.

Such an apparatus may enable reducing power consumption of a device and increase energy efficiency of the device, increasing coverage of uplink transmission, enabling networks to support new device categories with an odd number of antenna ports. Furthermore, the apparatus may enable enhanced channel estimates in terms of quality of channel estimates in the presence of different phase and/or coherence assumptions at the device side.

According to an example embodiment of the sixth aspect, the apparatus may be caused to perform the determining the mapping between the odd number of antenna ports and the first number of comb-offset values by: Determining the odd number of cyclic-shift values, one cyclic-shift value per antenna port within the odd number of antenna ports. Determining a third number of full antenna port groups. The third number may be a floor operation of the odd number divided by the second number. Each full antenna port group may comprise the second number of antenna port indices in an ascending order and the second number of cyclic-shift values in an ascending order. Associating the third number of comb-offset values within the first number of comb-offset values with the third number of full antenna port groups, comb-offset value per full antenna port group. Determining, in response to the third number being smaller than the first number, a partially full antenna port group comprising a fourth number of antenna port indices and the fourth number of cyclic-shift values. The fourth number may be the odd number decreased by the second number multiplied by the third number. Associating, in response to the third number being smaller than the first number, a remaining comb-offset value with the partially full antenna port group.

According to an example embodiment of the sixth aspect, the second number indicating antenna ports per comb-offset value may be comprised in the sounding reference signal resource configuration.

According to an example embodiment of the sixth aspect, the second number indicating antenna ports per comb-offset value may be a pre-determined value.

According to an example embodiment of the sixth aspect, the apparatus may be further caused to perform, prior to receiving the sounding reference signal resource configuration, at least one of the following: Transmitting, to the access node, an indication of uplink transmitting antenna port capability with the odd number of antenna ports. Transmitting, to the access node, an indication of phase coherence associated with the odd number of antenna ports. Transmitting, to the access node, an indication of amplitude coherence associated with the odd number of antenna ports.

According to a seventh aspect, an apparatus is disclosed. The apparatus may comprise at least one processor and at least one memory storing instructions that, when executed by the at least one processor, may cause the apparatus at least to perform: Receiving, from a user device, an indication of uplink transmitting antenna port capability with an odd number of antenna ports. The odd number may be at least three. Transmitting, to the user device, a sounding reference signal resource configuration for the odd number of antenna ports.

According to an example embodiment of the seventh aspect, the apparatus may be further caused to perform, prior to transmitting the sounding reference signal resource configuration: Receiving, from the user device, at least one of: an indication of phase coherence associated with the odd number of antenna ports or an indication of amplitude coherence associated with the odd number of antenna ports.

According to an eighth aspect, a method is disclosed. The method may be computer-implemented. The method may comprise: Receiving, from an access node, a sounding reference signal resource configuration for an odd number of antenna ports. The sounding reference signal configuration may comprise at least a first number of comb-offset values. The odd number may be at least three. Obtaining a second number indicating a number of antenna ports per comb-offset value. Determining, based on the sounding reference signal resource configuration and the second number, a mapping between the odd number of antenna ports and the first number of comb-offset values.

According to an example embodiment of the eighth aspect, the determining the mapping between the odd number of antenna ports and the first number of comb-offset values may comprise: Determining the odd number of cyclic-shift values, one cyclic-shift value per antenna port within the odd number of antenna ports. Determining a third number of full antenna port groups. The third number may be a floor operation of the odd number divided by the second number. Each full antenna port group may comprise the second number of antenna port indices in an ascending order and the second number of cyclic-shift values in an ascending order. Associating the third number of comb-offset values within the first number of comb-offset values with the third number of full antenna port groups, comb-offset value per full antenna port group. Determining, in response to the third number being smaller than the first number, a partially full antenna port group comprising a fourth number of antenna port indices and the fourth number of cyclic-shift values. The fourth number may be the odd number decreased by the second number multiplied by the third number. Associating, in response to the third number being smaller than the first number, a remaining comb-offset value with the partially full antenna port group.

According to an example embodiment of the eighth aspect, the method may further comprise, prior to receiving the sounding reference signal resource configuration: Transmitting, to the access node, an indication of uplink transmitting antenna port capability with the odd number of antenna ports. Transmitting, to the access node, an indication of phase and/or amplitude coherence associated with the odd number of antenna ports.

According to a ninth aspect, a method is disclosed. The method may be computer-implemented. The method may comprise: Receiving, from a user device, an indication of uplink transmitting antenna port capability with an odd number of antenna ports. The odd number may be at least three. Transmitting, to the user device, a sounding reference signal resource configuration for the odd number of antenna ports.

Any example embodiment may be combined with one or more other example embodiments. Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an exemplified wireless communication system;

FIG. 2 illustrates example functionalities of an apparatus according to an example embodiment;

FIG. 3 illustrates example functionalities of an apparatus according to an example embodiment;

FIG. 4 illustrates example functionalities of an apparatus according to an example embodiment;

FIG. 5 illustrates example functionalities of an apparatus according to an example embodiment;

FIG. 6 illustrates a signaling diagram according to an example embodiment;

FIG. 7 illustrates example functionalities of an apparatus according to an example embodiment;

FIG. 8 illustrates a schematic block diagram of an apparatus according to an example embodiment; and

FIG. 9 illustrates a schematic block diagram of an apparatus according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the specification may refer to “an”, “one”, or “some” embodiment(s) in several locations, this does not necessarily mean that each such reference is to the same embodiment(s), or that the feature may not apply to other embodiments. Single features of different embodiments may also be combined to provide other embodiments. Furthermore, words “comprising” and “including” should be understood as not limiting the described embodiments/examples to consist of only those features that have been mentioned and such embodiments/examples may contain also features/structures that have not been specifically mentioned.

Furthermore, although the numerative terminology, such as “first”, “second”, etc., may be used herein to describe various embodiments, elements, or features, it should be understood that these embodiments, elements, or features should not be limited by this numerative terminology. This numerative terminology is used herein only to distinguish one embodiment, element, or feature from another embodiment, element, or feature. For example, a first number discussed below could be called a second number, and vice versa, without departing from the teachings of the present disclosure.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. The embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WiAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

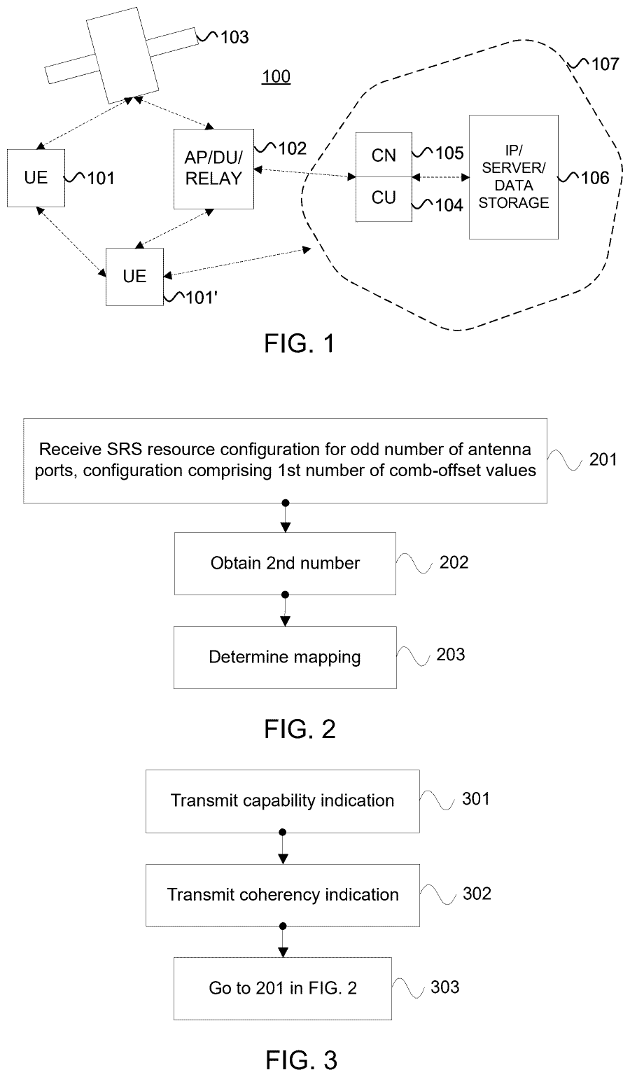

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network 100.

FIG. 1 shows user devices 101, 101′ configured to be in a wireless connection on one or more communication channels with a node 102. The node 102 is further connected to a core network 105. In one example, the node 102 may be an access node such as (e/g) NodeB providing or serving devices in a cell. In one example, the node 102 may be a non-3GPP access node. The physical link from a device to a (e/g) NodeB is called uplink or reverse link and the physical link from the (e/g) NodeB to the device is called downlink or forward link. It should be appreciated that (e/g) NodeBs or their functionalities may be implemented by using any node, host, server or access point etc. entity suitable for such a usage.

A communications system typically comprises more than one (e/g) NodeB in which case the (e/g) NodeB s may also be configured to communicate with one another over links, wired or wireless, designed for the purpose. These links may be used for signaling purposes. The (e/g) NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to devices. The antenna unit may comprise a plurality of antennas or antenna elements. The (e/g) NodeB is further connected to the core network 105 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), or access and mobility management function (AMF), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a device (e.g. a portable or non-portable computing device) that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g., to be used in smart power grids and connected vehicles. The user device may also utilize cloud. In some applications, a user device may comprise a user portable device with radio parts (such as a watch, earphones, eyeglasses, other wearable accessories or wearables) and the computation is carried out in the cloud. The device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple-input multiple-output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHZ-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput, and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets, and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 106, or utilize services provided by them. The communication network may also be able to support the usage of cloud services, for example at least part of core network operations may be carried out as a cloud service (this is depicted in FIG. 1 by “cloud” 107). The communication system may also comprise a central control entity, or a like, providing facilities for networks of different operators to cooperate for example in spectrum sharing.

The technology of Edge cloud may be brought into a radio access network (RAN) by utilizing network function virtualization (NVF) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes, or hosts. Application of cloud RAN architecture enables RAN real time functions being carried out at the RAN side (in a distributed unit, DU 102) and non-real time functions being carried out in a centralized manner (in a centralized unit, CU 104).

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). Each satellite 103 in the mega-constellation may cover several satellite-enabled network entities that create on-ground cells. The on-ground cells may be created through an on-ground relay node 102 or by a gNB located on-ground or in a satellite.

It is obvious for a person skilled in the art that the depicted system is only an example of a part of a radio access system and in practice, the system may comprise a plurality of (e/g) NodeBs, the user device may have an access to a plurality of radio cells and the system may comprise also other apparatuses, such as physical layer relay nodes or other network elements, etc. At least one of the (e/g) NodeBs or may be a Home (e/g) NodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

For fulfilling the need for improving the deployment and performance of communication systems, the concept of “plug-and-play” (e/g) NodeBs has been introduced. Typically, a network which is able to use “plug-and-play” (e/g) NodeBs, includes, in addition to Home (e/g) NodeBs (H (e/g) NodeBs), a home node B gateway, or HNB-GW (not shown in FIG. 1). A HNB Gateway (HNB-GW), which is typically installed within an operator's network may aggregate traffic from a large number of HNB s back to a core network.

In 5G and 6G networks, and beyond, it is envisaged that facilitating use of an odd number of antenna ports in association with UL SRS with antenna ports that may be, e.g., noncoherent, partially coherent, or fully coherent in phase and/or amplitude may enable a network to estimate UL CSI by using UL SRS antenna ports more reliably. An apparatus configured to an odd number of antenna ports capability may be configured to associate the odd number of antenna ports to SRS resources, e.g., as described below with FIGS. 2 to 6.

FIG. 2 illustrates an example functionality of an apparatus configured to transmit uplink sounding reference signal with an odd number of antenna ports according to an example embodiment.

Referring to FIG. 2, a sounding reference signal (SRS) resource configuration for an odd number of antenna ports is received in operation 201 from an access node. The odd number is at least three. The SRS resource configuration comprises at least a first number of frequency domain comb-offset values. In an example embodiment, the SRS resource configuration is received via, e.g., radio resource control (RRC) signaling. In an example embodiment, the comb-offset values are associated with a comb-type 2, 4, 8, or some other new comb-type, e.g., 12. In an example embodiment, the first number of comb-offset values are indicated with a bitmap.

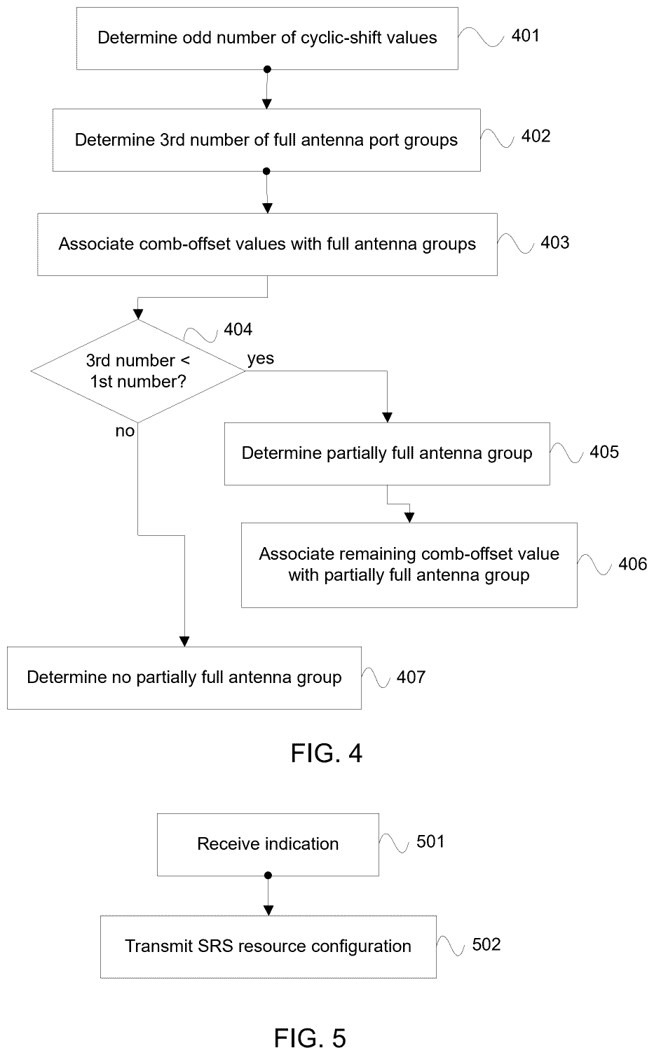

Referring to FIG. 2, a second number indicating a number of antenna ports per comb-offset value is obtained in operation 202. In an example embodiment, the second number may be comprised in the SRS resource configuration received from the access node. In an example embodiment, the second number may be a pre-determined value that may be read from a standard specification. A mapping between the odd number of antenna ports and the first number of comb-offset values is determined in operation 203, based on the SRS resource configuration and the second number. An example embodiment of the determining the mapping is explained in more detail below with reference to FIG. 4.

In an example embodiment, the odd number of antenna ports are mapped to comb-offset values within the first number of comb-offset values with a circular method. In an example embodiment, N antenna ports are mapped to M comb-offset values, wherein N≥M. An antenna port n∈N is mapped to a comb-offset value m∈M, wherein m=mod ((initial_co+n),M). The operator mod may be understood as the modulo operator, and initial_co may be understood as the initial comb-offset index the UE is configured with. In an example embodiment, N=3 antenna ports are mapped to M=2 comb-offset values (0, 1). If the initial comb-offset index the UE is configured with is 0, antenna port 1000 is mapped to comb-offset value 0, port 1001 is mapped to comb-offset value 1, and port 1002 is mapped to comb-offset value 0, that is, antenna ports (1000, 1001, 1002) to comb-offset values (0, 1, 0). If the initial comb-offset index is 1, antenna ports (1000, 1001, 1002) are mapped to comb-offset values (1, 0, 1). In an example embodiment, when N=5 antenna ports are mapped to M=3 comb-offset values (0, 1, 2) with the initial comb-offset index 2, antenna ports (1000, 1001, 1002, 1003, 1004) are mapped to comb-offset values (2, 0, 1, 2, 0).

In an example embodiment, comb-offset values within the first number of comb-offset values are indicated with a bitmap. In an example embodiment, when N=5 antenna ports are mapped to M=3 comb-offset values (0, 2, 3) with the initial comb-offset index 2, antenna ports (1000, 1001, 1002, 1003, 1004) are mapped to comb-offset values (3, 0, 2, 3, 0).

FIG. 3 illustrates an example functionality of an apparatus configured to transmit indications related to the odd number of antenna ports, prior to the receiving the SRS resource configuration, according to an example embodiment.

Referring to FIG. 3, an indication of uplink transmitting antenna port capability with the odd number of antenna ports is transmitted in operation 301 to the access node. An indication of phase coherence and/or amplitude coherence associated with the odd number of antenna ports is transmitted in operation 302 to the access node. The process continues in operation 303 to operation 201 in FIG. 2. In an example embodiment, only the indication of uplink transmitting antenna port capability is transmitted before continuing the process to operation 201 in FIG. 2. In an example embodiment, only the indication of phase coherence and/or amplitude coherence is transmitted before continuing the process to operation 201 in FIG. 2.

FIG. 4 illustrates an example functionality of an apparatus configured to determine the mapping between the odd number of antenna ports and the first number of comb-offset values according to an example embodiment. The process illustrated in FIG. 4 is assumed to be performed within operation 203 in FIG. 2.

Referring to FIG. 4, the odd number of cyclic-shift values is determined in operation 401, one cyclic-shift value per antenna port within the odd number of antenna ports. In an example embodiment, the cyclic-shift values may be comprised in the SRS resource configuration. Thus, there is determined the same number of cyclic-shift values as there are antenna ports within the odd number of antenna ports for which the SRS resource configuration is received. The determining the cyclic-shift values may be expressed as

$${α}_{i} = 2 π ( \frac{{n}_{SRS}^{cs , i}}{{n}_{SRS}^{cs , max}} ) ,$$

$${n}_{SRS}^{cs , i} = ceil ( ( {n}_{SRS}^{cs} + \frac{{n}_{SRS}^{cs , max} ( {p}_{i} - 1000 )}{{N}_{ap}^{SRS}} ) mod {n}_{SRS}^{cs , max} ) ,$$

where ceil( ) is an operator that returns a number rounded up, away from zero, to the nearest integer, pᵢ is an antenna port index, αᵢ is a cyclic-shift value for antenna port pᵢ, N_{SRS}^{cs,max} is a maximum number of cyclic shifts, and Nₐₚ^{SRS} is the number of antenna ports. The ceil operator is mandatory in the above equation to obtain integer value cyclic-shift offset values and to obtain actual phase values for the odd number of TX antenna ports.

Referring to FIG. 4, a third number of full antenna port groups are determined in operation 402. The third number is a floor operation of the odd number, divided by the second number. This may be expressed as

$${K}^{full} = floor ( \frac{{N}_{ap}^{SRS}}{L} ) ,$$

where K^{full} is the third number and L is the second number indicating the number of antenna ports per comb-offset value. Each full antenna port group comprises the second number of antenna port indices and the second number of cyclic-shift values. In an example embodiment, the antenna port indices and the cyclic-shift values are comprised in the full antenna port group in an ascending order. In an example embodiment, the antenna port indices and the cyclic-shift values are comprised in the full antenna port group in a descending order.

Referring to FIG. 4, the third number of comb-offset values within the first number of comb-offset values are associated in operation 403 with the third number of full antenna port groups, comb-offset value per full antenna port group. It is resolved in operation 404 whether the third number is smaller than the first number. If the third number is smaller than the first number (operation 404: yes), a partially full antenna port group is determined in operation 405. The partially full antenna port group comprises a fourth number of antenna port indices and the fourth number of cyclic-shift values. The fourth number is the odd number decreased by the second number multiplied by the third number. This may be expressed as

$${N}_{ap}^{SRS} - ( {K}^{full} \cdot L ) .$$

This may be understood as the partially full antenna group comprising the antenna port indices that are left over after determining the full antenna port groups. A remaining comb-offset value within the first number of comb-offset values is associated in operation 406 with the partially full antenna group. If the third number is smaller than the first number, the remaining comb-offset value that is not associated with any full antenna group within the third number of full antenna groups exists.

Referring to FIG. 4, if the third number is not smaller than the first number (operation 404: no), no partially full antenna group is determined in operation 407.

FIG. 5 illustrates an example functionality of an apparatus configured to transmit uplink sounding reference signal resource configuration for an odd number of antenna ports according to an example embodiment.

Referring to FIG. 5, an indication of uplink transmitting antenna port capability with an odd number of antenna ports is received in operation 501 from a user device (UE). The odd number is at least three. A sounding reference signal (SRS) resource configuration for the odd number of antenna ports is transmitted in operation 502 to the user device. In an example embodiment, an indication of phase and/or amplitude coherence associated with the odd number of antenna ports is also received in operation 501 from the user device, prior to the transmitting the SRS resource configuration to the user device.

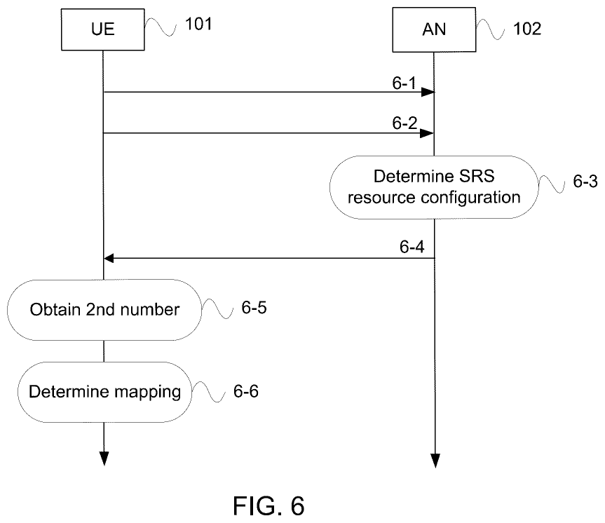

FIG. 6 illustrates a signaling diagram according to an example of information exchange in a communication network configured to utilize an odd number of antenna ports for uplink resources, wherein the odd number is at least three. The term “UE” is used for a user device configured to determine a mapping between the odd number of antenna ports and comb-offset values. The term “AN” is used for an access node configured to transmit a sounding reference signal resource configuration for the odd number of antenna ports. The access node may be, e.g., gNB or a distributed access node, comprising for example a centralized unit (CU) and a distributed unit (DU) enabling RAN real time functions being carried out at the RAN side (in the DU) and non-real time functions being carried out in a centralized manner (in the CU). The UE is assumed to be in a connected mode operation and an initial access with system information is assumed to have been obtained successfully from the AN or the network.

Referring to FIG. 6, the UE transmits (message 6-1) a message comprising an indication of uplink transmitting antenna port capability with an odd number of antenna ports to the AN, wherein the odd number is at least three. The UE transmits (message 6-2) a message comprising an indication of phase and/or amplitude coherence associated with the odd number of antenna ports to the AN. Upon receiving messages 6-1 and/or 6-2, a sounding reference signal (SRS) resource configuration is determined in block 6-3 by the AN for the odd number of antenna ports. The A N transmits (message 6-4) a message comprising the sounding reference signal resource configuration comprising at least a first number of comb-offset values to the UE. The UE obtains in block 6-5 a second number indicating a number of antenna ports per comb-offset value. In an example embodiment, the second number may be comprised in the SRS resource configuration received from the access node. In an example embodiment, the second number may be a pre-determined value. The UE determines in block 6-6 a mapping between the odd number of antenna ports and the first number of comb-offset values. The determining the mapping by the UE is explained in more detail above with reference to FIG. 4.

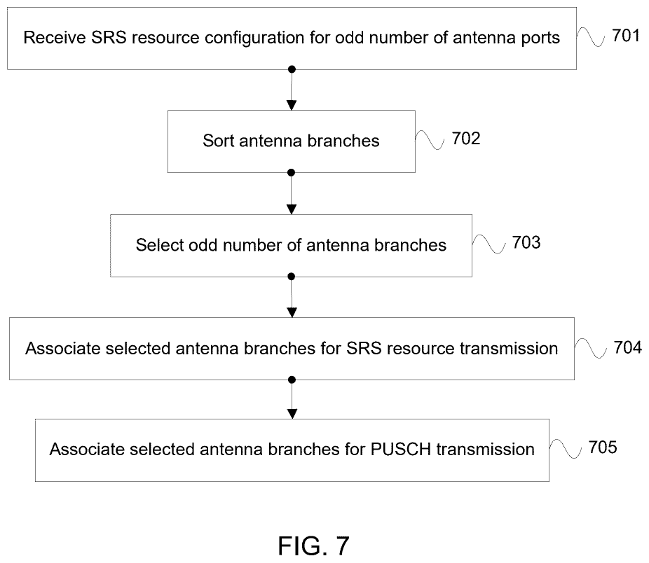

FIG. 7 illustrates an example functionality of an apparatus configured to select an odd number of antenna ports according to an example embodiment.

Referring to FIG. 7, a sounding reference signal (SRS) resource configuration for an odd number of antenna ports is received in operation 701. The odd number is at least three. A plurality of antenna branches associated with a plurality of implementation loss values are sorted in operation 702 in an ascending order according to the plurality of implementation loss values. An implementation loss value may be understood as loss resulting from, e.g., one or more of the following: routing from a primary transmitting antenna branch to antenna connectors, switching, coupling, or a usage of a different rated power amplifier (PA) with respect to the primary antenna branch. The odd number of antenna branches from within the plurality of antenna branches are selected in operation 703. The odd number of antenna branches are associated with the odd number of smallest implementation loss values from within the plurality of implementation loss values. The selected odd number of antenna branches are associated in operation 705 with the odd number of antenna ports for sounding reference signal resource transmission. The process may be understood as the user device ranking uplink (UL) transmitting (TX) antenna ports with respect to associated implementation losses.

In an example embodiment, the user device (UE) is equipped with four TX antenna branches and antenna ports, e.g., branch #0 with loss of 0 dB, branch #1 with loss of 4 dB, branch #2 with loss of 2 dB, and branch #3 with loss of 3 dB. The UE is configured with UL SRS resource configuration with three antenna ports, that is, the odd number Nₐₚ^{SRS}=3. The UE ranks the UL TX antenna branches in ascending order according to the implementation losses, resulting in a ranking branch #0, branch #2, branch #3, and branch #1. The UE then selects three “best” branches, that is, branch #0, branch #2, and branch #3, and associates them with UL SRS antenna ports as follows: UL SRS antenna port index 1000 with branch #0, UL SRS antenna port index 1001 with branch #2, and UL SRS antenna port index 1002 with branch #3.

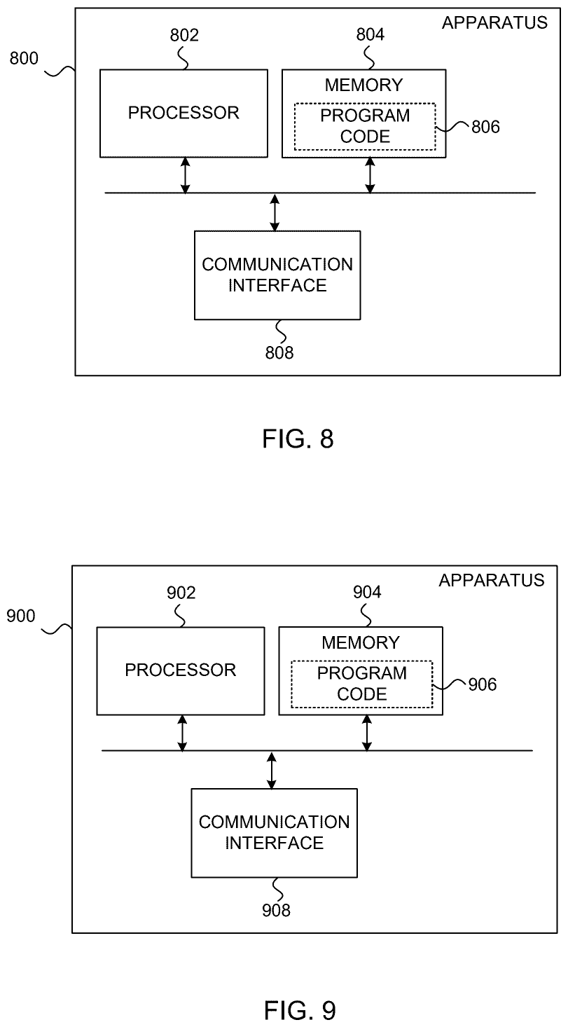

FIG. 8 illustrates an example embodiment of an apparatus 800, which may be an apparatus such as, or comprised in, a user device. The apparatus 800 may correspond to any of the user devices 101, 101′ of FIG. 1. The apparatus may also be called a subscriber unit, mobile station, remote terminal, access terminal, user terminal, terminal device, user equipment (UE), vehicle, or any electric device. Although the apparatus 800 is illustrated as a single device, it is appreciated that, wherever applicable, functions of the apparatus 800 may be distributed to a plurality of devices.

The apparatus 800 may comprise at least one processor 802. The at least one processor 802 may comprise, for example, one or more of various processing devices or processor circuitry, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 800 may further comprise at least one memory 804. The at least one memory 804 may be configured to store, for example, computer program code or the like, for example operating system software and application software. The at least one memory 804 may comprise one or more volatile memory devices, one or more non-volatile memory devices, and/or a combination thereof. For example, the at least one memory 804 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 800 may further comprise a communication interface 608 configured to enable the apparatus 800 to transmit and/or receive information to/from other devices. In one example, the apparatus 800 may use the communication interface 808 to transmit or receive signaling information and data in accordance with at least one data communication or cellular communication protocol. The communication interface 808 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas. The communication interface 808 may comprise a receiver, a transmitter, or a transceiver.

FIG. 9 illustrates an example embodiment of an apparatus 900, which may be an apparatus such as, or comprised in, an access node. The apparatus 900 may correspond to the access node 102 of FIG. 1 such as (e/g) NodeB or any access node, or in general a device configured to implement the functionalities or some of the functionalities described herein. Although the apparatus 900 is illustrated as a single device, it is appreciated that, wherever applicable, functions of the apparatus 900 may be distributed to a plurality of devices.

The apparatus 900 may comprise at least one processor 902. The at least one processor 902 may comprise, for example, one or more of various processing devices or processor circuitry, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 900 may further comprise at least one memory 904. The at least one memory 904 may be configured to store, for example, computer program code or the like, for example operating system software and application software. The at least one memory 904 may comprise one or more volatile memory devices, one or more non-volatile memory devices, and/or a combination thereof. For example, the at least one memory 904 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 900 may further comprise a communication interface 908 configured to enable the apparatus 900 to transmit and/or receive information to/from other devices. In one example, the apparatus 900 may use the communication interface 908 to transmit or receive signaling information and data in accordance with at least one data communication or cellular communication protocol. The communication interface 908 may be configured to provide at least one wireless radio connection, such as, for example, a 3GPP mobile broadband connection (e.g., 3G, 4G, 5G, 6G etc.). The communication interface 908 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas. The communication interface 908 may comprise a receiver, a transmitter, or a transceiver.

Referring to FIG. 8 and FIG. 9, when the apparatus 800, 900 is configured to implement some functionality, some component and/or components of the apparatus 800, 900, such as for example the at least one processor 802, 902 and/or the at least one memory 804, 904, may be configured to implement this functionality. Furthermore, when the at least one processor 802, 902 is configured to implement some functionality, this functionality may be implemented using program code 806, 906 comprised, for example, in the at least one memory 804, 904.

The functionality described herein may be performed, at least in part, by one or more computer program product components such as for example software components. According to an example embodiment, the apparatus 800, 900 may comprise a processor or processor circuitry, such as for example a microcontroller, configured by the program code when executed to execute the embodiments of the operations and functionality described. The program code 806, 906 is provided as an example of instructions which, when executed by the at least one processor 802, 902, cause performance of apparatus. Alternatively, or additionally, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

The apparatus 800, 900 may be configured to perform or cause performance of any aspect of the method(s) described herein. Further, a computer program may comprise instructions for causing, when executed, an apparatus to perform any aspect of the method(s) described herein. The computer program may be stored on a computer-readable medium. Further, the apparatus 800, 900 may comprise means for performing any aspect of the method(s) described herein. In one example, the means may comprise the at least one processor 802, 902, the at least one memory 804,904 including the program code 806, 906 (instructions) configured to, when executed by the at least one processor 802, 902, cause the apparatus 800, 900 to perform the method(s). In general, computer program instructions may be executed on means providing generic processing functions. The method(s) may be thus computer-implemented, for example, algorithm(s) executable by the generic processing functions, an example of which is the at least one processor 802, 902. The means may comprise transmission and/or reception means, for example one or more radio transmitters or receivers, which may be coupled or be configured to be coupled to one or more antennas, or transmitter(s) or receiver(s) of a wired communication interface.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (t) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile device or a similar integrated circuit in a sensor, a cellular network device, or another network device.

Although the subject matter has been described in language specific to structural features and/or acts, it is to be understood that the subject matter defined in the appended claims is not necessarily limited to the specific features or acts described above. Rather, the specific features and acts described above are disclosed as example embodiments of implementing the claims and other equivalent features and acts are intended to be within the scope of the claims.

It will be understood that the benefits and advantages described above may relate to one example embodiment or may relate to several example embodiments. The example embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the example embodiments described above may be combined with aspects of any of the other example embodiments described to form further example embodiments without losing the effect sought.

It will be understood that the above description is given by way of example embodiments only and that various modifications may be made by those skilled in the art. The above specification, example embodiments and data provide a complete description of the structure and use of exemplary embodiments. Although various example embodiments have been described above with a certain degree of particularity, or with reference to one or more individual embodiments, those skilled in the art could make numerous alterations to the disclosed example embodiments without departing from scope of this specification.

1. An apparatus comprising:
at least one processor; and
at least one memory storing instructions that, when executed by the at least one processor, cause the apparatus at least to perform:
receiving, from an access node, a sounding reference signal resource configuration for an odd number of antenna ports, wherein the odd number is at least three;
sorting a plurality of antenna branches associated with a plurality of implementation loss values in an ascending order according to the plurality of implementation loss values;
selecting the odd number of antenna branches from within the plurality of antenna branches, wherein the odd number of antenna branches are associated with the odd number of smallest implementation loss values from within the plurality of implementation loss values;
associating the selected odd number of antenna branches with the odd number of antenna ports for sounding reference signal resource transmission.

2. An apparatus according to claim 1, wherein the at least one processor and the at least one memory storing instructions that, when executed by the at least one processor, cause the apparatus further to perform:
associating the selected odd number antenna branches with the odd number of antenna ports for physical uplink shared channel transmission.

3. An apparatus according to claim 2, wherein the sounding reference signal configuration comprises at least a first number of comb-offset values, and wherein the at least one processor and the at least one memory storing instructions that, when executed by the at least one processor, cause the apparatus further to perform:
obtaining a second number indicating antenna ports per comb-offset value; and
determining, based on the sounding reference signal resource configuration and the second number, a mapping between the set of antenna ports and the first number of comb-offset values.

4. An apparatus according to claim 3, the at least one processor and the at least one memory storing instructions that, when executed by the at least one processor, cause the apparatus further to perform the determining the mapping between the odd number of antenna ports and the first number of comb-offset values by:
determining the odd number of cyclic-shift values, one cyclic-shift value per antenna port within the odd number of antenna ports;
determining a third number of full antenna port groups, wherein the third number is a floor operation of the odd number divided by the second number, and wherein each full antenna port group comprises the second number of antenna port indices in an ascending order and the second number of cyclic-shift values in an ascending order;
associating the third number of comb-offset values within the first number of comb-offset values with the third number of full antenna port groups, comb-offset value per full antenna port group;
determining, in response to the third number being smaller than the first number, a partially full antenna port group comprising a fourth number of antenna port indices and the fourth number of cyclic-shift values, wherein the fourth number is the odd number decreased by the second number multiplied by the third number; and
associating, in response to the third number being smaller than the first number, a remaining comb-offset value with the partially full antenna port group.

5. An apparatus according to claim 3, wherein the second number indicating antenna ports per comb-offset value is comprised in the sounding reference signal resource configuration.

6. An apparatus according to claim 3, wherein the second number indicating antenna ports per comb-offset value is a pre-determined value.

7. An apparatus according to claim 1, the at least one processor and the at least one memory storing instructions that, when executed by the at least one processor, cause the apparatus to perform, prior to the receiving the sounding reference signal resource configuration:
transmitting, to the access node, an indication of uplink transmitting antenna port capability with the odd number of antenna ports; and/or
transmitting, to the access node, an indication of phase and/or amplitude coherence associated with the odd number of antenna ports.

8. A method comprising:
receiving, from an access node, a sounding reference signal resource configuration for an odd number of antenna ports, wherein the odd number is at least three;
sorting a plurality of antenna branches associated with a plurality of implementation loss values in an ascending order according to the plurality of implementation loss values;
selecting the odd number of antenna branches from within the plurality of antenna branches, wherein the odd number of antenna branches are associated with the odd number of smallest implementation loss values from within the plurality of implementation loss values;
associating the selected odd number of antenna branches with the odd number of antenna ports for sounding reference signal resource transmission.

9. A method according to claim 8, further comprising:
associating the selected odd number antenna branches with the odd number of antenna ports for physical uplink shared channel transmission.

10. A method according to claim 8, further comprising:
obtaining a second number indicating antenna ports per comb-offset value; and
determining, based on the sounding reference signal resource configuration and the second number, a mapping between the set of antenna ports and the first number of comb-offset values.

11. A method according to claim 8, wherein the determining the mapping between the odd number of antenna ports and the first number of comb-offset values comprises:
determining the odd number of cyclic-shift values, one cyclic-shift value per antenna port within the odd number of antenna ports;
determining a third number of full antenna port groups, wherein the third number is a floor operation of the odd number divided by the second number, and wherein each full antenna port group comprises the second number of antenna port indices in an ascending order and the second number of cyclic-shift values in an ascending order;
associating the third number of comb-offset values within the first number of comb-offset values with the third number of full antenna port groups, comb-offset value per full antenna port group;
determining, in response to the third number being smaller than the first number, a partially full antenna port group comprising a fourth number of antenna port indices and the fourth number of cyclic-shift values, wherein the fourth number is the odd number decreased by the second number multiplied by the third number; and
associating, in response to the third number being smaller than the first number, a remaining comb-offset value with the partially full antenna port group.

12. A non-transitory computer-readable medium comprising program instructions for causing an apparatus to perform at least the following:
receiving, from an access node, a sounding reference signal resource configuration for an odd number of antenna ports, wherein the odd number is at least three;
sorting a plurality of antenna branches associated with a plurality of implementation loss values in an ascending order according to the plurality of implementation loss values;
selecting the odd number of antenna branches from within the plurality of antenna branches, wherein the odd number of antenna branches are associated with the odd number of smallest implementation loss values from within the plurality of implementation loss values;
associating the selected odd number of antenna branches with the odd number of antenna ports for sounding reference signal resource transmission.

13. A non-transitory computer program comprising instructions for causing an apparatus to perform at least the following:
receiving, from an access node, a sounding reference signal resource configuration for an odd number of antenna ports, wherein the odd number is at least three;
sorting a plurality of antenna branches associated with a plurality of implementation loss values in an ascending order according to the plurality of implementation loss values;
selecting the odd number of antenna branches from within the plurality of antenna branches, wherein the odd number of antenna branches are associated with the odd number of smallest implementation loss values from within the plurality of implementation loss values;
associating the selected odd number of antenna branches with the odd number of antenna ports for sounding reference signal resource transmission.
